(19) United States
(12) Patent Application Publication
(10) Pub. No.: US 2022/0028014 A1
(43) Pub. Date: Jan. 27, 2022

(54) Home History Records and Database

(71) Applicant: Michael J. Huth, Sarasota, FL (US)

(72) Inventor: Michael J. Huth, Sarasota, FL (US)

(21) Appl. No.: 17/375,112

(22) Filed: Jul. 14, 2021

Related U.S. Application Data
(60) Provisional application No. 63/054,282, filed on Jul. 21, 2020.

(51) Int. Cl. G06Q 50/16; G06F 16/9035; G06F 16/9038

(52) U.S. Cl. CPC G06Q 50/16; G06F 16/9038; G06F 16/9035

(57) ABSTRACT

This present invention relates to a comprehensive information system for residential addresses, which is capable of listing the entire maintenance, service, repair, et. al. history of a home, or real property, at a specific address. The information system provides a complete history of all relevant repairs, service calls, and all other home renovations, replacements, maintenance, upgrades, etc. at a specific address, and ensures the buyers and/or sellers are fully aware of all the collective work that has been completed at the property before finalizing a property deal. Additionally, the information system provides an easy-to-use interface which enables the users to quickly retrieve a report comprising information related to relevant service calls, repairs, visits, and more (i.e. work completed) on a required address.

### CROSS-REFERENCE TO RELATED APPLICATION

The present application claims priority to, and the benefit of, U.S. Provisional Application No. 63/054,282, which was filed on Jul. 21, 2020 and is incorporated herein by reference in its entirety.

### FIELD OF THE INVENTION

The present invention relates generally to the field of real estate. More specifically, the present invention relates to a comprehensive information software system for residential property. The information software system features building a real property profile including a listing of the entire maintenance and repair history of a home at a specific address, and allows a user to search for property history by simply inputting an address into a search bar of the information software system. The invention provides a list of all relevant repairs and service calls at an address, thereby ensuring the prospective buyer or seller can obtain a complete history of a real estate property in order to make a more informed decision regarding the purchase or sale of the property. The information software system and database can include a subscription fee or a flat-fee pricing system to offer unlimited use of the program. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, real estate business deals with the buying, selling, management, operation, or investment of real property, land and buildings. Purchasing or buying real property, such as a home, is one of the biggest investments made by an individual. Every residential property undergoes some kind of repair and maintenance during its lifetime, and therefore, at the time of a purchase of a home, a great level of transparency and disclosure regarding the home is required between a buyer and a seller, particularly for the purchasers. Therefore, buying and/or selling a residential property can be an immensely stressful process. Buyers and sellers may be unaware of the complete history of the house during negotiations. Even if a seller discloses the history of the residential property for the deal, there is always a chance of overlooking relevant repair and maintenance information of the residential property to be sold. There may have been maintenance and repairs completed on the home without the current owner's knowledge. In such cases, crucial information will not become known to the purchaser, and they may get frustrated during or after purchasing the home. Even after buying the home, if new information related to repairs and maintenance is disclosed later, people may not feel confident with the deal. Repeated discoveries of maintenance, repairs, etc. on a newly-purchased home can be alarming, or it can be reassuring to know that a property was well-maintained.

Typically, buyers rely on the information disclosed by the current owner of the home. However, the current owner may themselves not be aware of some facts about the home, thereby leaving some important information undisclosed to the buyers. Further, the buyers may connect with neighbors, or other indirect sources of information, to extract additional information regarding the repair and maintenance of the home to be bought. Furthermore, the buyer may connect with residential property management committees and homeowners' associations (HOA) to get information related to repairs, maintenance, taxes and more. However, there is always a chance of missing out on some relevant and crucial information related to the home, and the information received through neighbors or other sources may be erroneous or misleading.

Therefore, there exists a long felt need in the art for a platform which provides information related to residential properties for both potential buyers and sellers. There is also a long felt need in the art for an information software system which provides exhaustive and complete information on repairs and maintenance of residential property such as homes and other real property. Additionally, there is a long felt need in the art for an information database which eliminates the need for buyers to connect with neighbors, real estate management committees, or HOAs to gain additional indirect information on a property. Moreover, there is a long felt need in the art for an information system which provides all the relevant and crucial repair and maintenance information for a home or any other real property. Further, there is a long felt need in the art for an information system which provides accurate repair and maintenance information for a home, and ensures the buyers/purchasers of a safe real estate deal. Furthermore, there is a long felt need in the art for an information system which ensures all the repair and maintenance information is disclosed to the buyers before the deal is finalized. Finally, there is a long felt need in the art for an information system that ensures the home buyers and sellers are fully aware of all maintenance completed at the property.

The subject matter disclosed and claimed herein, in one potential embodiment, comprises a system for creating and providing a home (i.e. real property) profile including a compiled report of all repairs, visits, service calls, etc., of a property. The system comprises: a user interface for a user to login, subscribe and input an address of a property for information related to a property; a server configured to retrieve repair, service, insurance and legal information from a plurality of operatively-connected databases; and a report module to prepare a report containing the retrieved information and description of the property wherein the server is accessed after authorization of the user. The server updates information in the databases from a plurality of third-party data sources and the system allows the user to view all relevant service calls to the address to help prospective home buyers and sellers become fully aware of all maintenance completed at a property. The user interface can be offered by a smartphone application (i.e. app) or a webpage, and is adapted for use on laptops, desktop computers, smartphones, tablets and more.

In this manner, the novel complete home profile history system of the present invention accomplishes all of the forgoing objectives, and provides a relatively easy, convenient and efficient solution of listing all repair and maintenance information related to a home thereby ensuring the buyers and sellers are fully aware of all pertinent information before finalizing any real estate deal. The complete home address history system of the present invention can be accessed on subscription, or can be optioned for unlimited use as per the requirements of the user. Accordingly, the user may pay a subscription fee or a flat-fee pricing system to access the system in a desired manner.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one potential embodiment, comprises a system for creating and providing a home profile including a compiled report of all repairs, visits, service calls, etc., of a property. The system comprises: a user interface for a user to login, subscribe and input an address of a property for information related to a property; a server configured to retrieve repair, service, insurance and legal information from a plurality of operatively-connected databases; and a report module to prepare a report containing the retrieved information and description of the property wherein the server is accessed after authorization of the user. The server updates information in the databases from a plurality of third-party data sources and the system allows the user to view all relevant service calls to the address to help prospective home buyers and sellers become fully aware of all maintenance completed at a property. The user interface can be offered by a smartphone application or a webpage, and is adapted for use on laptops, desktop computers, smartphones, tablets and more.

In a further embodiment of the present invention, a method for compiling a profile including maintenance and service information of a residential property to a prospective buyer or seller is disclosed and comprises: receiving an address of a real estate property for which the maintenance, insurance and service information is to be provided, wherein a user inputs the address on a user interface; determining a property corresponding to the address; retrieving the maintenance, service, insurance and legal information for the property from a plurality of databases; compiling a report containing the retrieved information; and, displaying the report on the user interface in an online manner for viewing and downloading by the user, wherein the information included in the report is based on a subscription level of the user.

In yet a further embodiment of the present invention, a non-transitory computer-readable storage medium comprising computer-readable instructions that cause a processor executing the computer-readable instructions to effectuate operations is disclosed. The storage medium and instructions comprise: providing a plurality of databases; the databases including information and details of various maintenance services performed on a residential property; receiving an address of a real estate property for which the maintenance, insurance and service information is required; identifying a property corresponding to the address; retrieving the maintenance, service, insurance, legal, et. al. information for the property; and, compiling an online report containing the retrieved maintenance, service, insurance, legal, et. al. information which can be downloaded and used for discussions and negotiations during both the selling and buying of the property.

The method, application, software and system of the present invention are particularly advantageous because they provide a comprehensive information system for residential addresses. A report or profile containing a list of all relevant repairs and services done at a desired address is provided to ensure that a prospective buyer, renter, or seller gets all the required relevant information, including the insurance and legal information. Based on the subscription level of a user, a subset of information can be provided to the user.

In yet still a further embodiment of the present invention, a method of building a home or real property profile, and enabling sharing of the home profile, is disclosed. The method comprises: registering a user device associated with a first user and at least a second user with a home profile system app; creating a first home profile of the first user, wherein the first home profile includes information selected from a group consisting of a service call, an insurance claim, a legal proceeding, a maintenance item, a repair, an upgrade, a renovation and a replacement; entering the first home profile into the home profile system app; inputting an address into a user interface of the home profile system app by the second user; searching the address to determine if the address matches the first home profile; receiving a request for the first home profile; compiling a report of the first home profile; accessing the report of the first real property profile by the at least second user; downloading the first home profile on the user interface of the second user; and, displaying the first home profile on the user interface of the at least second user.

In one embodiment, a notification can be sent to a prospective buyer, renter or seller in case any information is updated of the desired property. In addition to the third-party data sources, information in blogs, newspapers, magazines, websites, and the like can be utilized and aggregated to provide inputs to the system. The information in the system of the present invention is collected from both publicly available data sources and private data sources.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic diagram of one possible embodiment of the property maintenance and repair history retrieval system of the present invention as per the disclosed architecture;

FIG. 2 illustrates a block diagram showing exemplary sources of information from which the maintenance and repair history retrieval system of the present invention collates information as per the disclosed architecture;

FIG. 3 illustrates a flow diagram showing steps to provide a home profile including maintenance and repair information to a user in the form of a report available online using the maintenance and repair information retrieval system of the present invention as per the disclosed architecture;

FIG. 4 illustrates a flow diagram showing steps of signing up and selecting a subscription method by a user to access information from the maintenance and repair information retrieval system of the present invention as per the disclosed architecture;

FIG. 5 illustrates a flow diagram showing how the report containing information of the property is used and shared by a buyer or seller after receiving the report from the maintenance and repair information retrieval system;

FIG. 6 illustrates a perspective view showing a user logging in the software application of maintenance and repair information retrieval system on an electronic device;

FIG. 7 illustrates a perspective view showing a user logging in the software application of home profiles including maintenance and repair information retrieval system on a smartphone;

FIG. 8 illustrates a perspective view showing a user searching for a property in the software application of maintenance and repair information retrieval system;

FIG. 9 illustrates a perspective view showing partial details of a searched property on the user interface as per the disclosed structure; and

FIG. 10 illustrates a perspective view showing a partial report in a downloadable form of a searched property on the user interface as per the disclosed structure.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a platform which provides information related to residential properties for prospective buyers, renters and sellers. There is also a long felt need in the art for an information software system which provides a home profile; including exhaustive information on repairs and maintenance of real property, such as homes. Additionally, there is a long felt need in the art for an information database which eliminates the need for buyers to connect with neighbors, real estate management committees, or HOAs (i.e. indirect sources) to gain additional information on a property. Moreover, there is a long felt need in the art for an information system which provides all the relevant and crucial repair and maintenance information for a home or any other real property. Further, there is a long felt need in the art for an information system which provides accurate repair and maintenance information for a home, and ensures the buyers or renters of a safe real estate arrangement. Furthermore, there is a long felt need in the art for an information system which ensures all the repair and maintenance information is disclosed to the buyers/renters before a deal is finalized. Finally, there is a long felt need in the art for an information system that ensures the home buyers, renters, and sellers are fully aware of all maintenance completed at the property.

The present invention, in one potential embodiment, comprises a system for creating and providing a home profile including a compiled report of all repairs, visits, service calls, etc., of a property. The system comprises: a user interface for a user to login, subscribe and input an address of a property for information related to a property; a server configured to retrieve repair, service, insurance and legal information from a plurality of operatively-connected databases; and, a report module to prepare a report containing the retrieved information and description of the property wherein the server is accessed after authorization of the user. The server updates information in the databases from a plurality of third-party data sources and the system allows the user to view all relevant service calls to the address to help prospective home buyers and sellers become fully aware of all maintenance completed at a property. The user interface can be offered by a smartphone application or a webpage and is adapted for use on laptops, desktop computers, smartphones, tablets, and more.

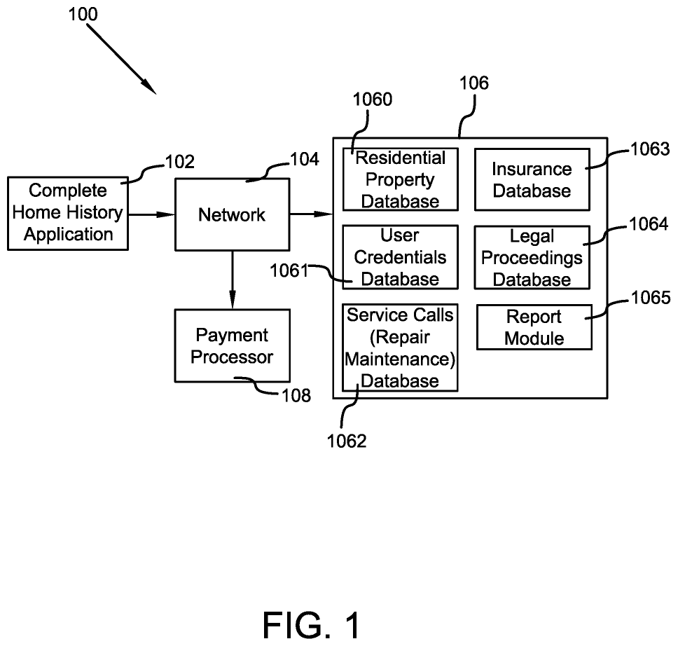

Referring initially to the drawings, FIG. 1 illustrates a schematic diagram showing a real property profile system including a maintenance and repair history retrieval system of the present invention as per the disclosed architecture. As shown, the property maintenance and repair history retrieval system 100 includes a software application or a webpage interface 102 through which the user can access the system 100. The software application is embodied as computer-implemented instructions stored in a computer-readable medium of an electronic device. The webpage interface can be accessed easily through a browser by entering a URL address in the address bar. A communication network 104 such as an internet connection can be used to reach or access the web server with an operatively-connected database 106. The web server with operatively-connected databases 106 can be a central server, a distributed server or a cloud server. The web server with operatively-connected databases 106 contains a plurality of repositories or databases with the information pertaining to the maintenance, repair, insurance, insurance, and other relevant data required for a seller, buyer or renter to get complete information of a real property such as a residential property.

The web server with operatively-connected databases 106 includes a residential property database 1060 that contains details of the properties along with the address. The address is mapped to a geographical location and details of a property corresponding to the address or a GPS location can be retrieved from the residential property database 1060. The residential property database 1060 may also have images and other descriptions of the property. A user credential database 1061 is used for authorization of a user before providing the information about a property. The credentials of the user are verified along with the subscription plan of the user using the credential database 1061. A service history database 1062 stores all the details of repair and maintenance corresponding to the properties and can be retrieved to provide to users. Insurance database 1063 is an optional database and contains the insurance and historical claim information of a real property. Based on the subscription level of a user, insurance details from the insurance database 1063 can be provided to the user.

To provide details of any closed or pending legal proceedings on a property, the legal proceedings database 1064 is used to give additional information indicating legal information of the property. This information is generally available as public information and therefore can be ‘scraped’ (i.e. web scraped and readily obtained by a buyer or real estate agent and compiled into the system 100). Web scraping refers to the process of extracting data from web sources and structuring it into a more convenient format. The server 106 further has a report module 1065 to prepare reports in various formats to present to the user wherein the report module 1065 compiles the report containing all the relevant information from various databases described above in a templatized form. The compiled report is presented to the user on the software application or a webpage interface 102 and can be downloaded or forwarded by the user.

It should be noted that the information included in the report does not contain any confidential information of the present or past owners of the property searched using the software application or a webpage interface 102. Further, for subscription of the system 100 by a user to retrieve desired reports, a payment processor 108 is also present in the system 100. The smartphone application 102 can be downloaded from a playstore such as Google® playstore or Apple® playstore and can be made compatible for all mobile operating systems.

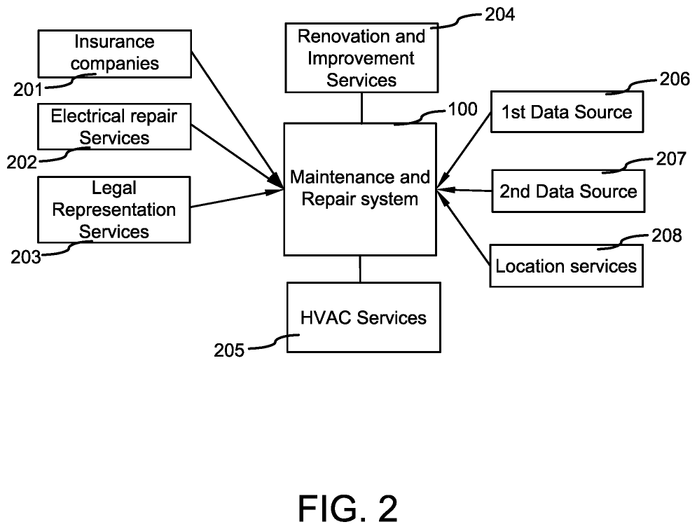

FIG. 2 illustrates a block diagram showing exemplary sources of information from which the maintenance, repair, service, et. al. history-retrieval system of the present invention collates information and creates a home profile as per the disclosed architecture. A plurality of sources including private sources and government sources are used for information sources pertaining to maintenance, repairs, upgrades, renovations, and insurance claims of a real property. The sources are automatically ‘scraped’ by the system 100 to update the databases periodically to include updates for the properties. For insurance information of properties, insurance companies 201 can provide information, for example, premium and claim history, to the system 100 and can be included in a report provided by the system 100 to a user of the system 100.

Exemplary repositories of potential information include: electrical repair services 202 that provided electrical repairs and bill information of properties in the system 100; legal representation services 203 that provided legal information and ownership information of properties in the system 100; renovation and home improvement services 204 that provided information related to kitchen repair, window installation, gate installation, gutter cleaning, bathroom repair, painting and siding, roof replacement, foundation work, renovations, plumbing improvements, electrical upgrades, other repairs, upgrades, renovations, and replacements, etc. of properties in the system 100; individual services provided to the real property can be part of the repositories made available to the system 100; and, HVAC services 205 that provided replacement systems, repairs and maintenance of properties in the system 100. It is to be appreciated that the above listing of home services is for illustration purposes. The actual types of specific services is much more comprehensive. However, the services generally fall into the broad categories of maintenance, repair, upgrade, renovation and replacement.

Location services 208 provide the nearby location-specific information to the system 100 and updates periodically to give an overview of the surrounding area of a property. An example of surrounding property information can include sale prices of homes in the same general vicinity of the subject real property. It should be appreciated that depending on the scope of the information included in the system 100 of the present invention, additional data sources and repositories can be searched such as a 1st data source 206 and 2nd data source 207. The system 100 can be connected to any number of data sources or repositories to include exhaustive information to be provided to a user about a property.

All the data sources can connect to the system 100 or the server 106 through a network and can provide information through a communication network. The system 100 processes the received information to store in the operatively-connected databases to provide to the users of the system 100.

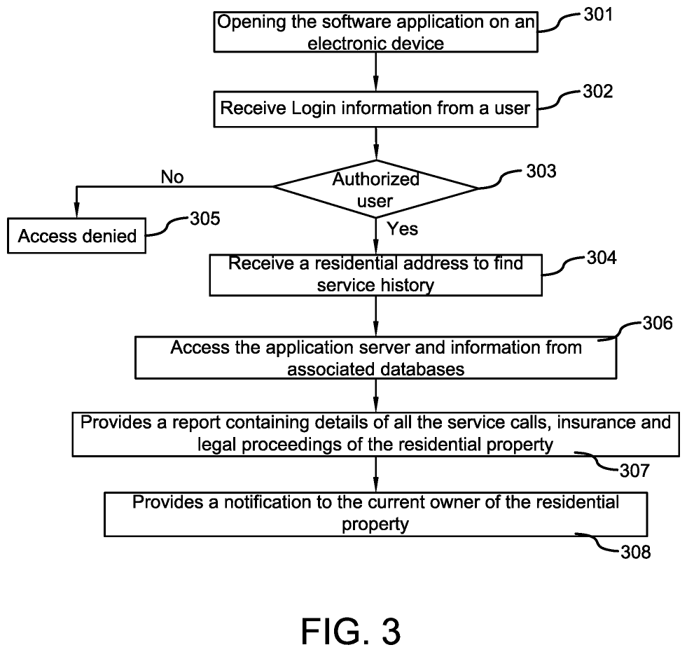

FIG. 3 illustrates a flow diagram showing steps to provide a home profile including maintenance and repair information to a user in the form of a report available online using the maintenance and repair information retrieval system of the present invention as per the disclosed architecture. Initially, the software application is opened/accessed on an electronic device (Block 301). The maintenance and repair information retrieval system receives the login information from a user for authorization (Block 302). Then, it is determined if the user is authorized or not (Block 303). If it is determined that the user is not authorized, then the access is denied (Block 304). If it is determined that the user is authorized, then the system receives a residential address to find service and maintenance history associated with the real property (Block 305). Next, the required information is retrieved from the operatively-connected databases and repositories depending on the subscription plan of the user (Block 306). After compiling a report containing the pertinent information, for example details of all the service calls, insurance, and legal proceedings of the searched property, is provided online to the user which can be displayed on a smartphone application or a webpage and can be downloaded by the user (Block 307). An optional step to maintain privacy or security of the information of the property, a notification along with the report may be sent to the owner of the property which is searched by the user using the application (Block 308).

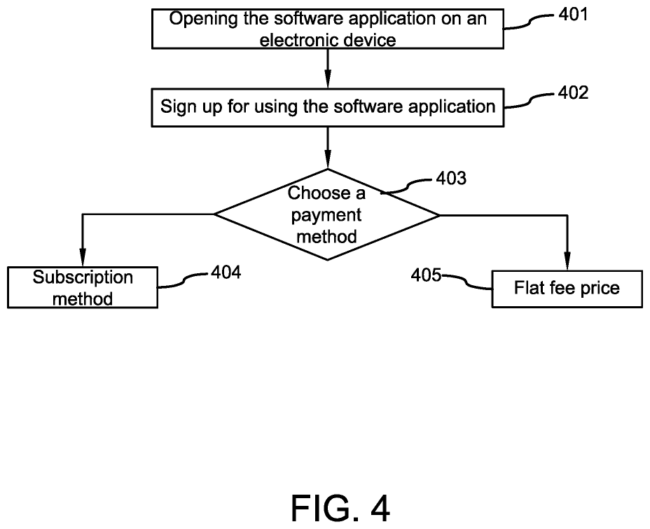

FIG. 4 illustrates a flow diagram showing the process of signing up and selecting a subscription method by a user to access information from the maintenance and repair information retrieval system of the present invention as per the disclosed architecture. Initially, the software application is opened by a user on an electronic device (Block 401). The user signs up on the software application (Block 402) using his or her login and password. After signing up, the user selects one of the subscription plans 404 or the flat fee plan 405, and can save the payment information for later use. Based on the plan chosen by the user, information is included in the report for the user. The flat fee gives unlimited usage of the services and the subscription fees gives limited use of the service.

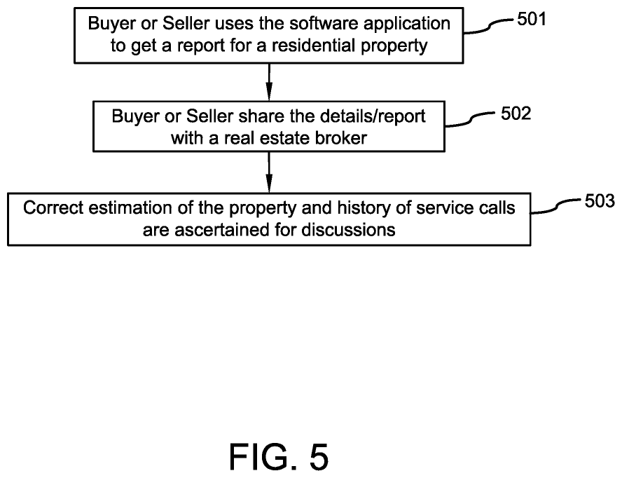

FIG. 5 illustrates a flow diagram showing how the profile or report containing information of the real property is used and shared by a buyer or seller after receiving the report from the maintenance and repair information retrieval system. As shown, a buyer or seller uses the software application to get a profile or report for one or more residential properties (Block 501). Then, as per the requirement, the buyer or seller shares the details/report with a real estate broker to help in selling or buying the property (Block 502). The details of the report are used for correct estimation of the property and history of service calls are ascertained for discussions regarding the sale and value of the real property (Block 503).

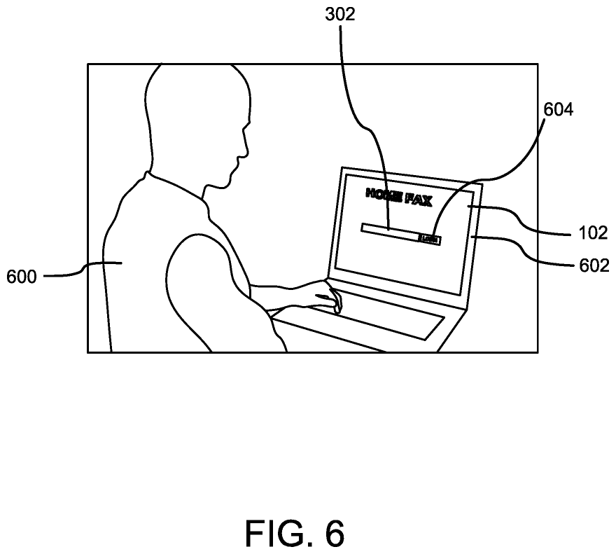

FIG. 6 illustrates a perspective view showing a user logging into the software application of the maintenance and repair information retrieval system on an electronic device. As shown, a user 600 can log into the software application 102 by inputting credentials 302 using the login header 604 on an electronic device such as a laptop 602. The login can be inputted on a webpage accessed via a browser or through a desktop application. To access real property information, the user 600 can log into the application to provide secure access to the user 600.

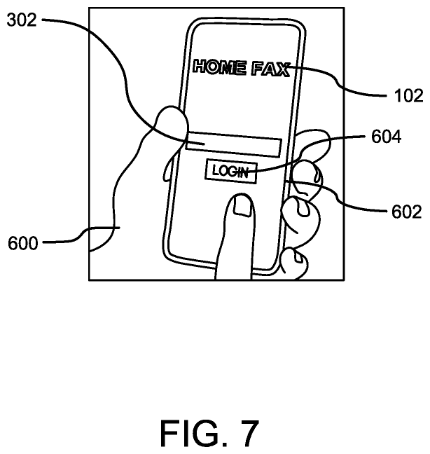

FIG. 7 illustrates a perspective view showing a user logging into the software application of the maintenance and repair information retrieval system on a smartphone. Using a smartphone 602, the installed smartphone application 102 provides the user interface to a user 600 to provide login information 302 to enter into the system 100 of the present invention. Once the user 600 is successfully authenticated and authorized, the user 600 can enter the location or address of a real property to search for repair, maintenance, insurance and any other property-related information.

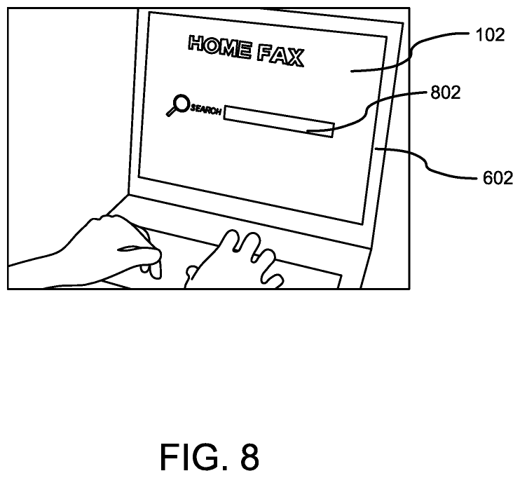

FIG. 8 illustrates a perspective view showing a user searching for a real property in the software application of property maintenance and repair information retrieval system. As shown, on the user interface 102, a search bar 802 is provided into which the user can input an address of a property such as a residential property. The search can be performed on any electronic device such as a laptop 602. After the address is searched, a profile containing all the available service history information, et. al. is displayed on the user interface 102.

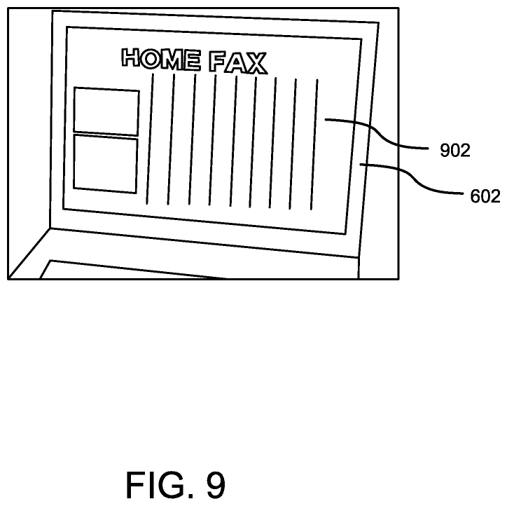

FIG. 9 illustrates a perspective view showing details of a searched property on the user interface as per the disclosed structure. Once an address is searched by a user, the maintenance and service retrieval system 100 of the present invention displays a description 902 of the property. The description 902 can include images, a brief overview, and additional details in a downloadable form regarding the history of the subject real property.

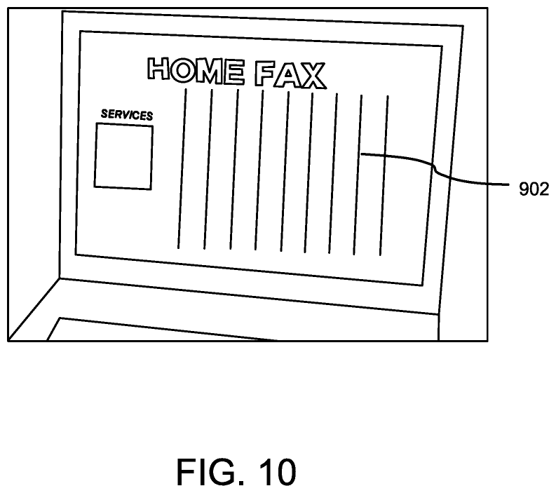

FIG. 10 illustrates a perspective view-showing report in a downloadable form of a searched property on the user interface as per the disclosed structure. The report 902 of the searched property can be displayed on the user interface of the smartphone application 102 and can be downloaded by the user for discussions and negotiations. The report is delivered to the user in an online report accessible through a personal customizable portal with user login credentials, or a report is emailed or printed and delivered in hard copy form to the user. The report can also be customized based on location, price or subscriber preference. The report 902 lists a small sample of the myriad number of services and repairs that can be conducted on a real property.

The report generator of the system 100 compiles all the requested information from the various data sources, data repositories, and any other sources of data and generates a report therefrom for the user. The property buyer may use this report to make the final decision as to whether to proceed with the property purchase transaction for this particular property.

Many of the features of the maintenance and service calls retrieval and displaying methods and systems described above include computing elements, such as servers, processors, and the like. A person skilled in the art will appreciate that software, firmware or some combination thereof may be used to perform one or more of the functions of the disclosed surveillance system. The software and/or firmware may be any suitable computer-readable medium that has computer-executable instructions that may be executed by any computing machine or other computing device. It should be appreciated that variations of the above-disclosed data gathering repository systems and other features and functions, or alternatives thereof, may be desirably combined into many other different systems, methods or applications.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “property maintenance and repair information retrieval system”, “maintenance and repair history retrieval system”, and “system for creating and providing a compiled report” are interchangeable and refer to the property maintenance and repair information retrieval system 100 of the present invention.

Notwithstanding the forgoing, the property maintenance and repair information retrieval system 100 of the present invention can include any additional component to enhance the functionality and efficiency of the property maintenance and repair information retrieval system 100. One of ordinary skill in the art will appreciate that the configuration, components of the property maintenance and repair information retrieval system 100 as shown in the FIGS. are for illustrative purposes only, and that many other configuration and components are well within the scope of the present disclosure.

Various modifications and additions can be made to the exemplary embodiments discussed without departing from the scope of the present invention. While the embodiments described above refer to particular features, the scope of this invention also includes embodiments having different combinations of features, and embodiments that do not include all of the described features. Accordingly, the scope of the present invention is intended to embrace all such alternatives, modifications and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method of building a home profile and enabling sharing of the home profile, the method comprising the steps of:
registering a user device associated with a first user and at least a second user with a home profile system app;
creating a first home profile of said first user, wherein said first home profile includes information selected from a group consisting of a service call, an insurance claim, a legal proceeding, a maintenance item, a repair, an upgrade, a renovation, and a replacement;
entering said first home profile into said home profile system app;
inputting an address into a user interface of said home profile system app by said at least second user;
searching said address to determine if said address matches said first home profile;
receiving a request for said first home profile;
compiling a report of said first home profile;
downloading said first home profile on said user interface of said at least second user; and
displaying said first home profile on said user interface of said at least second user.

2. The method of claim 1, wherein said first user is an owner of real property corresponding to said address of said first home profile.

3. The method of claim 2, wherein said at least second user is a prospective buyer of said real property corresponding to said address of said first home profile.

4. The method of claim 2, wherein said at least second user is a real estate agent.

5. The method of claim 3, wherein said first home profile includes information from publicly available data sources.

6. The method of claim 5, wherein said first home profile includes information from privately available data sources.

7. The method of claim 3 further comprising a step of paying a subscription fee by said at least second user for downloading said first home profile on said user interface of said at least second user.

8. The method of claim 4 further comprising a step of paying a subscription fee by said at least second user for downloading said first home profile on said user interface of said at least second user.

9. The method of claim 2 further comprising a step of notifying said first user of said request for said first home profile.

10. A method of generating a real property profile for a group of users connected on a content sharing platform, the method comprising the steps of:
registering a user device associated with a first user and at least a second user with a real property profile system app;
creating a first real property profile of said first user, wherein said first real property profile includes information selected from a group consisting of a service call, an insurance claim, a legal proceeding, a maintenance item, a repair, an upgrade, a renovation, and a replacement;
entering said first real property profile into said real property profile system app;
inputting an address into a user interface of said real property profile system app by said at least second user;
searching said address to determine if said address matches said first real property profile;
receiving a request for said first real property profile;
compiling a report of said first real property profile; and
accessing said report of said first real property profile by said at least second user.

11. The method of claim 10, wherein said first user is an owner of real property corresponding to said address of said first real property profile and said at least second user is a prospective buyer of said real property corresponding to said address of said first real property profile.

12. The method of claim 10, wherein said first user is an owner of real property corresponding to said address of said first real property profile and said at least second user is a real estate agent of said real property corresponding to said address of said first real property profile.

13. The method of claim 11 further comprising a step of downloading said first real property profile on said user interface of said at least second user.

14. The method of claim 13 further comprising a step of displaying said first real property profile on said user interface of said at least second user.

15. The method of claim 14, wherein said first real property profile includes information from publicly available data sources.

16. The method of claim 15, wherein said first real property profile includes information from privately available data sources.

17. The method of claim 16 further comprising a step of paying a subscription fee by said at least second user for downloading said first real property profile on said user interface of said at least second user.

18. The method of claim 17 further comprising a step of notifying said first user of said request for said first real property profile.

19. The method of claim 12 further comprising a step of downloading said first real property profile on said user interface of said at least second user, and displaying said first real property profile on said user interface of said at least second user.

20. The method of claim 19 further comprising a step of paying a subscription fee by said at least second user for downloading said first real property profile on said user interface of said at least second user.
